(19) United States
(12) Patent Application Publication
(10) Pub. No.: US 2007/0294222 A1
(43) Pub. Date: Dec. 20, 2007

(54) ON-DEMAND NEWS SERVICE BASED ON END-USER REQUESTED AND GENERATED CONTENT

(75) Inventors: Kari Laurila, Tampere (FI); Teemu Jalava, Espoo (FI)

Correspondence Address: BANNER & WITCOFF, LTD., TEN SOUTH WACKER DRIVE, SUITE 3000, CHICAGO, IL, 60606, US

(73) Assignee: Nokia Corporation, ESPOO (FI)

(21) Appl. No.: 11/424,411

(22) Filed: Jun. 15, 2006

(51) Int. Cl. G06F 17/30

(52) U.S. Cl. 707/3

(57) ABSTRACT

A news system, user computing devices, and wireless feeder devices communicate through a network to provide on-demand news content to users of the user computing devices. The users of the user computing device's requests play an active role in guiding the generation of news content for the news system. Users may also use a miss indication button to play an active role in the on-demand news service. Furthermore, user's prior content queries are used to enhance the semantical and geographical analysis of current content queries to locate relevant content.

### FIELD OF THE INVENTION

This invention relates generally to content communication. More particularly, aspects of the invention relate to systems, apparatuses, and methods for requesting, generating, and providing content in an on-demand news service.

### BACKGROUND OF THE INVENTION

News stories and photographs are delivered to the public these days through various means. One way of delivering news is through a news anchor on a television or radio station. The news anchor delivers to the public whatever news is deemed newsworthy beforehand by their station programmers. In addition, the station programmers are limited to news stories provided to them by professional news reporters. A viewer/listener is unable to request on-the-fly that a news story about a particular event or particular location be provided. The public is left with little to no input on what news stories they are forced to hear. Another way of delivering news is through the Internet. For example, Internet website operators, such as Google® and Yahoo!®, categorize news stories and organize the news stories in various ways. For example, Google® may organize its news stories by subject matter (e.g., business, sports, technology, politics, etc.). Meanwhile, Yahoo!® may organize its news stories according to a hierarchy of regions (e.g., world, Europe, U.S., Texas, Illinois, Chicago, etc.). In both cases, the website operators may allow a website visitor to enter search phrases to find desirable news stories. If no news story is found matching the website visitor's search phrase, the visitor may simply be informed that no matching results were found. The website visitor is left to either modify the search phrase to better describe the news story or look to an alternate news source (e.g., a competitor's Internet website).

Therefore, there is a need in the art for a robust news service where the user plays a active role in the requesting and generating of news content.

### SUMMARY OF THE INVENTION

The following represents a simplified summary of some embodiments of the invention in order to provide a basic understanding of various aspects of the invention. This summary is not an extensive overview of the invention. It is not intended to identify key or critical elements of the invention or to delineate the scope of the invention. Its sole purpose is to present some embodiments of the invention in simplified form as a prelude to the more detailed description that is presented below.

In order to overcome the aforementioned deficiencies in the prior art and other problems that will become apparent after reading this disclosure, the present invention provides systems, methods, and apparatuses for the requesting, generating, and providing of news content.

In one embodiment, a computer-implemented method of communicating content to and from a news system to provide an on-demand news service is disclosed. The news system receives and processes content queries from users of user computing devices. If content corresponding to a content query is available on the news system, the content is transmitted to the user computing device. However, if the content is not available, then a popularity indicator is updated and compared to a predetermined popularity threshold value. Depending on this comparison, the user of the user computing device is sent a miss indication or a qualified miss indication. One or more wireless feeder devices may be used to request additional content in some circumstances.

In another embodiment, an overload indicator is updated and compared to a predetermined overload threshold value, and the news system acts in response accordingly.

In yet another embodiment, an apparatus (e.g., user computing device) in communication with a news system for providing on-demand news content to a user of the user computing device is disclosed. The apparatus may be comprised of various units, including a processor for performing steps to receive content from the news system. The apparatus may transmit a content query to the news system and receive either: the requested content, incorrect content, a miss indication, or a qualified miss indication. The user of the apparatus may use a miss indication button to indicate when incorrect or deficient content is provided.

### BRIEF DESCRIPTION OF THE DRAWINGS

FIG. 1 depicts an illustrative operating environment in accordance with aspects of the invention.

FIG. 2 shows an illustrative flowchart of a method for communicating content to and from a news system to provide an on-demand news service in accordance with aspects of the invention.

FIG. 3 shows an illustrative flowchart of various steps executed by a processor programmed with computer-executable instructions in accordance with aspects of the invention.

### DETAILED DESCRIPTION OF THE INVENTION

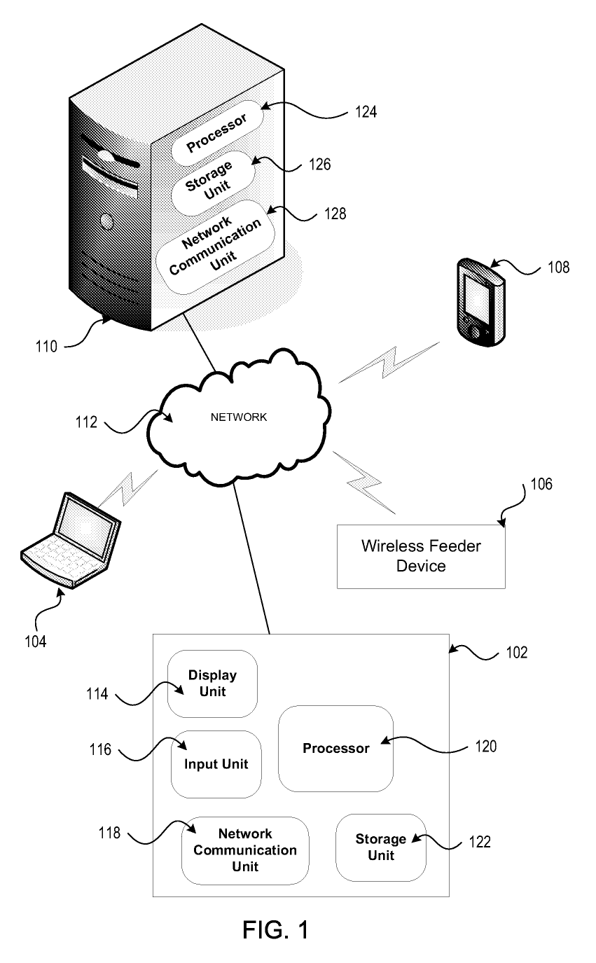

FIG. 1 depicts an illustrative operating environment in accordance with aspects of the invention. A user of a user computing device 102 in communication with a news system 110 through a network 112 may transmit a content query to the news system 110. The user computing device 102 may be a laptop computer 104, personal computer, handheld computing device (e.g., a PDA), mobile phone, or any other appropriate computing device connected to the network 112. The user computing device 102 may be comprised of various units including, but not limited to, a display unit 114 (e.g., a touchscreen, computer monitor, mobile phone screen, etc.), input unit 116 (e.g., a stylus, keyboard, mobile phone interface, etc.), network communication unit 118 (e.g., Ethernet card, IEEE 802.11 capabilities, dial-up modem, cable-modem, etc.), storage unit 122 (e.g., RAM, ROM, non-volatile memory, hard drive, etc.), and processor 120 (e.g., a microprocessor, Intel® Pentium processor, AMD® processor, programmable logic board, etc.). The storage unit 122 may store computer-executable instructions on a computer-readable medium. Moreover, the processor 120 may execute the computer-executable instructions to perform steps in accordance with various aspects of the invention.

The news system 110 may be comprised of one or more computers and/or servers capable of communicating through the network 112 to receive and transmit data. The news system 110 may be comprised of various units including, but not limited to, a network communication unit 128 (e.g., Ethernet card, IEEE 802.11 capabilities, dial-up modem, cable-modem, etc.), storage unit 126 (e.g., RAM, ROM, non-volatile memory, hard drive, etc.), and processor 124 (e.g., a microprocessor, Intel® Pentium processor, AMD® processor, programmable logic board, etc.). The storage unit 126 may store computer-executable instructions on a computer-readable medium. Moreover, the processor 124 may be coupled to the storage unit 126 and execute the computer-executable instructions to perform steps in accordance with various aspects of the invention. In another example, the processor 124 may be programmed with computer-executable instructions in accordance with aspects of the invention.

The news system 110, as will be explained in detail below, may select and transmit requests for content from a wireless feeder device 106 in wireless communication with the network 112. Wireless feeder devices may include, but are not limited to, mobile phones 108, wireless handheld devices such as PDAs, laptop computers with global positioning system (GPS) capabilities, digital cameras with wireless capabilities and other appropriate wireless devices. The network 112 may be made up of one or more wired networks (e.g., LAN, Ethernet, ISDN, DSL, cable, dial-up, etc.) and/or wireless networks (e.g., WAN, WiFi, Bluetooth, IEEE 802.11, satellite, etc.).

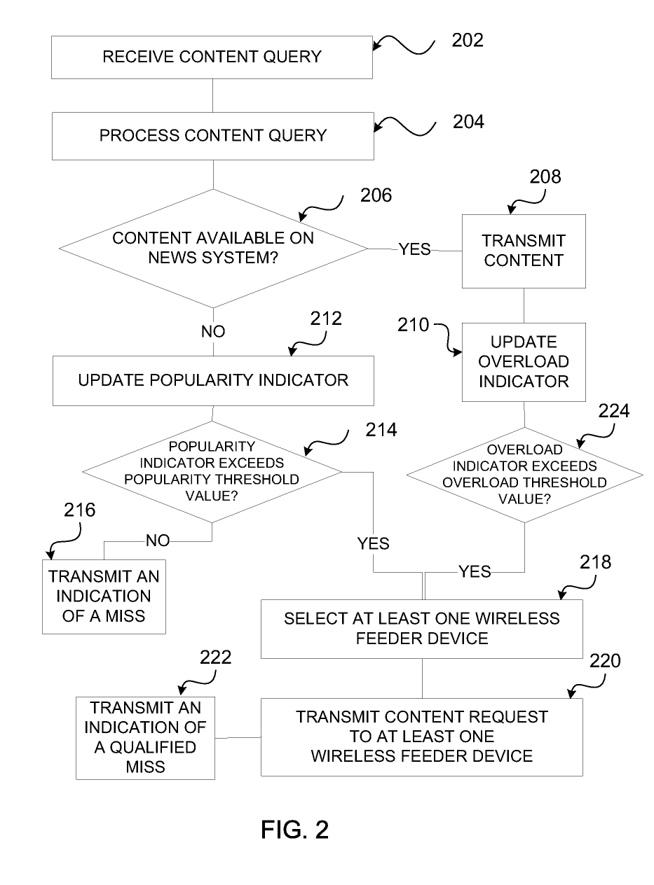

FIG. 2 is an illustrative flowchart of a method for communicating content to and from a news system to provide an on-demand news service. In one example in accordance with aspects of the invention, the content may be news information comprising human-readable information. Examples of human-readable information include, but are not limited to, text of a news story and photographs from an event. News information formatted in extensible markup language (XML) or other similar formats (e.g., hypertext markup language (HTML), wireless markup language (WML), etc.) are additional examples of human-readable information because they convey information to a user after they have been processed or parsed appropriately.

In step 202, the news system 110 receives through the network communication unit 128 a content query from a user computing device 102 in communication with the news system. The content query may be search keywords with or without boolean connectors. In another embodiment, the user may indicate a location or region on a map displayed on the user computing device 102. In that case, the content query is comprised of the location information corresponding to the location or region indicated by the user. For example, the location information may be a street address, street intersection, zip code, city, state, or some other regional designation. At least one benefit of providing a map interface is the increase ease with which a user may construct a content query. In another example, the content query may be comprised of both location information indicated on a map and textual information provided by the user. At least one benefit of such an embodiment is the increased focus with which a user may construct a content query.

In step 204, the processor 124 in the news system 110 processes the content query to determine if content corresponding to the content query is available on the news system. While processing the content query, the news system may perform a semantical analysis of the content query to identify a core location and/or core event relating to the content corresponding to the content query. For example, when a user desires news content about a particular event taking place at a particular location, the user's content query might contain keywords relating to the location and event. The news system performs a semantical analysis using, among other things, keyword comparisons to attempt to identify a core location and/or core event for the content query. The core location and/or core event may act as an index to the content. Thus, if a first user sends a content query of “chicago baseball game today” and a second user sends a content query of “wrigley baseball May 11”, then the semantical analysis is able to identify that both content queries are referring to the same core location and core event (i.e., the Chicago Cubs playing baseball at Wrigley Field today, May 11). In this example, the core location may be “Wrigley Field” and the core event may be “baseball game.”

In another example in accordance with aspects of the invention, the semantical analysis of the content query in step 204 may be based, at least in part, on prior related content queries. The news system 110 may record prior content queries that users have provided for a particular core location and/or core event. Thus, the semantical analysis may be based on historical information collected by the news system. In one example, a hundred users submit content queries with the objective of obtaining content about the Chicago Cubs playing baseball at Wrigley Field today, May 11, but they use different keywords in their content queries. The news system updates its historical information to indicate the different keywords (e.g., Chicago, Wrigley, baseball, etc.) that users use when requesting content about this particular core location and core event. Therefore, the news system 110 is better equipped to use semantics to analyze a content query received from a user computing device 102.

In an alternative embodiment, during step 204 the news system may perform a geographic analysis of the content query to identify a core location and core event relating to the content corresponding to the content query. A geographic analysis may be appropriate when, for example, the user uses a map display to construct a content query, as was explained earlier. In that case, the content query may be comprised of location information. The geographic analysis may include identifying core locations at or near the location information. Furthermore, as with symantical analysis, prior related content queries may also be used, at least in part, in the geographic analysis of the content query. For example, many users selecting a location near Addison Street and Clark Street (i.e., the location of Wrigley Field) on the day of a Chicago Cubs baseball game may be used during geographic analysis to identify Wrigley Field as the core location and Chicago Cubs baseball game as the core event.

If the news system finds (in step 206) that the content corresponding to the content query is available on the news system, then in step 208 the news system 110 transmits through the network communication unit 128 the content to the user computing device 102. Meanwhile, if the news system finds (in step 206) that the content corresponding to the content query is not available on the news system, then in step 212 the news system 110 updates a popularity indicator related to the content. A popularity indicator may be an incremental counter for monitoring the number of times a request for a particular content results in a miss (i.e., the content is not available on the news system). At least one benefit of a popularity indicator is the enhanced responsiveness of the news system to users' collective desires. The news system 110 may set a predetermined popularity threshold value to designate when there is sufficient user demand for particular content. For example, the predetermined popularity threshold value may be set to ‘10’ (i.e., 10 requests for the same missing content) and stored in the storage unit 126.

The news system 110 compares (in step 214), the popularity indicator to a predetermined popularity threshold value. If the popularity indicator exceeds the predetermined popularity threshold value, then the news system selects (in step 218) at least one wireless feeder device 106 in communication with the news system 110, transmits (in step 220) a content request to those wireless feeder devices, and transmits (in step 222) an indication of a qualified miss to the user computing device 102. Although step 222 appears last in the flowchart of FIG. 2, it need not necessarily be performed after step 218 and step 220. At least one advantage of performing step 222 before step 220 is the shortened wait time resulting for the user of the user computing device 102 that submitted a content query. The indication of a qualified miss transmitting in step 222 may be any numeric, symbolic, or other indication informing the user of a user computing device that although the content corresponding to the user's content query is not available currently, a request has been submitted for the content. The qualified miss indicates to a user that should he/she reenter the content query after a lapse of time, the result may be different (i.e., the news system may have content corresponding to the content query at a later time).

In one example in accordance with aspects of the invention, the news system may select (in step 218) at least one wireless feeder device based on the features available on each of the wireless feeder devices. For example, a wireless feeder device 106 with camera functionality may be desirable for an accident event, while microphone functionality may be desirable for a speaking event (e.g., a politician's speech). In addition, the news system may also select (in step 218) at least one wireless feeder device based, at least in part, on the physical location of the wireless feeder devices. In one example, the news system may be able to determine the physical location of a wireless feeder device 106 using global positioning system (GPS) capabilities in the wireless feeder device 106 or using other locater technologies. At least one benefit of using physical location in selecting a wireless feeder device is that the device may be more likely to obtain the content for the particular core location and core event requested.

In step 220, the news system 110 transmits a content request to the appropriate wireless feeder devices. A content request may be comprised of location information and event information. The location information and event information may be used by the wireless feeder device 106 to determine the content to provide the news system 110. The wireless feeder device 106 transmits the appropriate content to the news system 110 and the content is indexed along with the other content in the news system 110.

When the news system compares (in step 214) the popularity indicator to a predetermined popularity threshold value, if the popularity indicator does not exceed the predetermined popularity threshold value, then the news system transmits (in step 216) an indication of a miss to the user computing device 102. The indication of a miss transmitting in step 216 may be any numeric, symbolic, or other indication informing the user of a user computing device that the content corresponding to the user's content query is not available from the news system 1 10.

Referring to FIG. 2, if the content corresponding to the content query is available on the news system (in step 206), the news system may update (in step 210) an overload indicator relating to the content. An overload indicator, like a popularity indicator, may be an incremental counter for monitoring the number of times a request for a particular content is successfully found and transmitted to the user. The overload indicator may be used to monitor the level of demand for a particular content and may be stored in the storage unit 126. If content for a particular core location and core event are in high demand (i.e., the overload indicator for the content is a large value), it may be desirable to request additional content from selected wireless feeder devices 106.

Furthermore, the news system compares (in step 224) the overload indicator to a predetermined overload threshold value. In one example, the predetermined overload threshold value may be set to ‘20’ (i.e., 20 requests for the same content). If the overload indicator exceeds the predetermined overload threshold value, the news system selects (in step 218) at least one wireless feeder device in communication with the news system and transmits (in step 220) a content request to those wireless feeder devices. As explained earlier, the news system selects (in step 218) at least one wireless feeder device based on the features available on each of the wireless feeder devices. As also explained earlier, the news system may select (in step 218) at least one wireless feeder device based, at least in part, on the physical location of the wireless feeder devices.

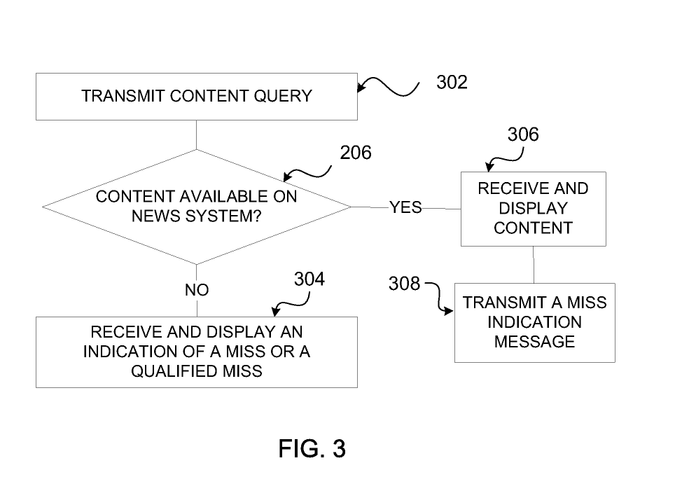

FIG. 3 shows an illustrative flowchart of various steps executed by a processor programmed with computer-executable instructions in accordance with aspects of the invention. The processor 120 may be part of a user computing device 102, and the processor 120 may coupled to a storage unit 122 and programmed with computer-executable instructions for performing steps for requesting and generating content. For example, in step 302, a processor 120 on a user computing device 102 may perform instructions to transmit a content query to a news system 110. The processor 120 may utilize the network communication unit 118 to actually transmit the content query to the news system 110 through the network 1 12. After the news system receives (in step 202, FIG. 2) and processes (in step 204, FIG. 2) the content query, the news system 110 determines (in step 206) if the content query corresponds to content available on the news system. If the news system 110 determines (in step 206) that the content is not available on the news system, then the news system performs some additional steps (e.g., steps 212, 214, 218, and/or 220, FIG. 2) before transmitting an appropriate message to the user computing device 102. The user computing device 102 receives and displays (in step 304) the message to the user on the display unit 114. Depending on the value of the popularity indicator (see step 214, FIG. 2), the news system 110 may send an indication of a miss or an indication of a qualified miss. These indications were described in detail earlier.

Meanwhile, if the content is available on the news system, the news system sends the content accordingly. The user computing device 102 receives and displays (in step 306) the content to the user on the display unit 114. The user of the user computing device 102 may review the content provided and indicate (by providing user input) if the content provided failed to satisfy the user's content query. The user may indicate this by pressing the miss indication button (i.e., any input means on the input unit 116 of the user computing device 102 designated as indicating that the content returned for a content query is incorrect or deficient). In accordance with aspects of the invention, the news system 110 receives a miss indication message from the user computing device 102 in response to content transmitted to the user computing device, if the user presses the miss indication button. The miss indication button is one aspect of the invention that allows the user to play an active role in requesting and generating content. The news system 110 processes the miss indication message and may use it accordingly in the semantical and geographical analysis (in step 204, FIG. 2) it performs. For example, a miss indication message may be used to adjust historical information collected by the news system 110 based on prior related content queries.

While it is understood that the invention may be implemented as a method, it may also be implemented in a computer readable medium having computer-executable instructions. Aspects of the invention may be implemented by way of software, hardware, or a combination thereof. Computer-readable media includes any available media that can be access by a processor in a computing device or system (e.g., news system 110, user computing device 102, wireless feeder device 106). Other features of the invention will become apparent from the foregoing detailed description when taken in conjunction with the drawings.

The present invention has sometimes been described in terms of preferred and illustrative embodiments thereof. Numerous other embodiments, modifications and variations within the scope and spirit of the appended claims will occur to persons of ordinary skill in the art from a review of this disclosure.

We claim:

1. A method comprising:
(a) receiving a content query from a user computing device in communication with a news system;
(b) processing the content query to determine if content corresponding to the content query is available on the news system;
(c) if the content corresponding to the content query is available on the news system, then transmitting the content to the user computing device; and
(d) if the content corresponding to the content query is not available on the news system, then:
(i) updating a popularity indicator related to the content; and
(ii) if the popularity indicator exceeds a predetermined popularity threshold value, selecting at least one wireless feeder device in communication with the news system and transmitting a content request to the at least one wireless feeder device.

2. The method of claim 1, wherein the content is news information comprising human-readable information, and the content request comprises location information and event information.

3. The method of claim 1, wherein (b) comprises performing a semantical analysis of the content query to identify a core location and core event relating to the content corresponding to the content query.

4. The method of claim 3, wherein the semantical analysis of the content query is based at least in part on prior related content queries.

5. The method of claim 1, wherein (b) comprises performing a geographic analysis of the content query to identify a core location and core event relating to the content corresponding to the content query, wherein the content query comprises location information.

6. The method of claim 5, wherein the geographic analysis of the content query is based at least in part on prior related content queries.

7. The method of claim 1, comprising:
updating an overload indicator relating to the content if the content corresponding to the content query is available on the news system in (b); and
if the overload indicator exceeds a predetermined overload threshold value, selecting the at least one wireless feeder device and transmitting a content request to the at least one wireless feeder device.

8. The method of claim 1, comprising:
in response to transmitting the content to the user computing device in (c), receiving a miss indication message from the user computing device and processing the miss indication message.

9. The method of claim 1, wherein selecting at least one wireless feeder device is based on features available on each of the at least one wireless feeder device.

10. The method of claim 9, wherein selecting at least one wireless feeder device is based at least in part on a physical location of each of the at least one wireless feeder device.

11. The method of claim 1, wherein if the content corresponding to the content query is not available on the news system, then:
transmitting an indication of a miss if the popularity indicator does not exceed a predetermined popularity threshold value; and
transmitting an indication of a qualified miss if the popularity indicator exceeds a predetermined popularity threshold value.

12. An apparatus comprising:
a network communication unit;
a storage unit; and
a processor coupled to the storage unit and programmed with computer-executable instructions to perform a method comprising:
(a) receiving a content query from a user computing device in communication with a news system;
(b) processing the content query to determine if content corresponding to the content query is available on the news system;
(c) if the content corresponding to the content query is available on the news system, then transmitting the content to the user computing device; and
(d) if the content corresponding to the content query is not available on the news system, then:
(i) updating a popularity indicator related to the content;
(ii) if the popularity indicator exceeds a predetermined popularity threshold value, selecting at least one wireless feeder device in communication with the news system, transmitting a content request to the at least one wireless feeder device, and transmitting an indication of a qualified miss; and
(iii) if the popularity indicator does not exceed a predetermined popularity threshold value, transmitting an indication of a miss.

13. The apparatus of claim 12, wherein (b) comprises performing a semantical analysis of the content query to identify a core location and core event relating to the content corresponding to the content query.

14. The apparatus of claim 12, wherein (b) comprises performing a geographic analysis of the content query to identify a core location and core event relating to the content corresponding to the content query, wherein the content query comprises location information.

15. The apparatus of claim 12, comprising computer-executable instructions to perform the method comprising:
updating an overload indicator relating to the content if the content corresponding to the content query is available on the news system in (b); and
if the overload indicator exceeds a predetermined overload threshold value, selecting the at least one wireless feeder device and transmitting a content request to the at least one wireless feeder device.

16. An apparatus comprising:
a display unit;
an input unit, the input unit having a miss indicator button;
a network communication unit;
a storage unit; and
a processor coupled to the storage unit and programmed with computer-executable instructions to perform a method comprising:
transmitting a content query to a news system using the network communication unit;
in response to transmitting a content query, receiving and displaying on the display unit content from the news system if the content query corresponds to content on the news system; and
transmitting a miss indication message to the news system in response to the miss indication button being pressed.

17. The apparatus of claim 16, wherein the apparatus is a mobile phone in communication with a news system.

18. The apparatus of claim 17, wherein the miss indication button is a predetermined input on the input unit of the mobile phone.

19. The apparatus of claim 16, comprising computer-executable instructions to perform the method comprising:
in response to transmitting a content query, if the content query does not correspond to content on the news system, receiving and displaying one of: an indication of a miss and an indication of a qualified miss.

20. A computer-readable medium storing computer-executable instructions for performing a method comprising:
(a) receiving a content query from a user computing device in communication with a news system;
(b) processing the content query to determine if content corresponding to the content query is available on the news system;
(c) if the content corresponding to the content query is available on the news system, then transmitting the content to the user computing device; and
(d) if the content corresponding to the content query is not available on the news system, then:
(i) updating a popularity indicator related to the content;
(ii) if the popularity indicator exceeds a predetermined popularity threshold value, selecting at least one wireless feeder device in communication with the news system and transmitting a content request to the at least one wireless feeder device;
(iii) transmitting an indication of a miss if the popularity indicator does not exceed a predetermined popularity threshold value; and
(iv) transmitting an indication of a qualified miss if the popularity indicator exceeds a predetermined threshold value.

21. The computer-readable medium of claim 20, comprising computer-executable instructions for the method comprising:
updating an overload indicator relating to the content if the content corresponding to the content query is available on the news system in (b); and
if the overload indicator exceeds a predetermined overload threshold value, selecting the at least one wireless feeder device and transmitting a content request to the at least one wireless feeder device.

22. The computer-readable medium of claim 20, comprising computer-executable instructions for the method comprising:
in response to transmitting the content to the user computing device in (c), receiving a miss indication message from the user computing device and processing the miss indication message.
